(19) United States
(12) Patent Application Publication
(10) Pub. No.: US 2011/0057991 A1
(43) Pub. Date: Mar. 10, 2011

(54) Inkjet head and manufacturing method thereof

(75) Inventors: Suk Ho Song, Ansan (KR); Jae Woo Joung, Suwon (KR); Pil Joong Kang, Suwon (KR)

(73) Assignee: SAMSUNG ELECTRO-MECHANICS CO., LTD., Suwon (KR)

(21) Appl. No.: 12/654,305

(22) Filed: Dec. 16, 2009

(30) Foreign Application Priority Data
Sep. 7, 2009 (KR) 10-2009-0084208

(51) Int. Cl. B41J 2/14; B29C 65/00

(52) U.S. Cl. 347/44; 156/60

(57) ABSTRACT

There is provided an inkjet head and a manufacturing method thereof. The inkjet head includes an upper substrate formed of a silicon material and having an ink chamber storing ink provided therein; an intermediate substrate bonded to the upper substrate, formed of a low temperature co-fired ceramic material, and having a connection path and a restrictor provided therein while the connection path and the restrictor are connected to the ink chamber; and a lower substrate bonded to the intermediate substrate, formed of a silicon material, and having a nozzle connected to the connection path provided therein. According to the inkjet head and the manufacturing method thereof, the densification and facilitation of bonding between substrates are achieved by using anodic bonding between a silicon substrate and a ceramic substrate, thereby improving manufacturing yield.

### CROSS-REFERENCE TO RELATED APPLICATIONS

This application claims the priority of Korean Patent Application No. 10-2009-0084208 filed on Sep. 7, 2009, in the Korean Intellectual Property Office, the disclosure of which is incorporated herein by reference.

### BACKGROUND OF THE INVENTION

1. Field of the Invention

The present invention relates to an inkjet head and a manufacturing method thereof, and more particularly, to an inkjet head and a manufacturing method thereof allowing for improved manufacturing yield due to the densification and facilitation of bonding between substrates by using anodic bonding between a silicon substrate and a ceramic substrate.

2. Description of the Related Art

An inkjet head converts electric signals into physical impulses so that ink droplets are ejected through small nozzles. In the inkjet head, several structures may be formed to perform various functions. A piezoelectric material (PZT) may be used for an actuator allowing the inkjet head to be driven. Also, materials such as stainless steel, ceramic and silicon may be used for the inkjet head structures.

With recent developments in semiconductor technology accompanied by developments in silicon wafer processing technology, it is now possible to manufacture an inkjet head without a separate adhesive layer, by processing each layer of the inkjet head to be a silicon wafer and bonding the layers together by silicon direct bonding. In the case of stainless steel or ceramic, a polymer adhesive layer may be needed for bonding each layer. In the case of silicon, however, such an adhesive layer is not required. Accordingly, such an inkjet head not requiring an adhesive layer may eject a variety of functional ink, as compared to the inkjet head having the adhesive layer. Also, the inkjet head formed of stainless steel or ceramic may require molds for manufacturing the structures and may not readily allow for changes in design, whereas the structures of the inkjet head formed of silicon may readily be modified by employing a photolithography method. Accordingly, the inkjet head, manufactured by fabricating the structures formed of silicon having a low chemical reaction rate and bonding them together by silicon direct bonding, may be appropriate in an industrial inkjet market. However, silicon direct bonding has disadvantages such as being a difficult process, having low yield, and being a time-consuming process.

A method of manufacturing an inkjet head using single-crystal silicon wafers according to the related art may include fabricating structures having respective functions from two or three wafers and bonding them together.

In order to manufacture an inkjet head using silicon wafers, several structures such as a chamber and a membrane may need to be formed, and then a bonding process may be required for integrating the structures. The bonding process may be performed by aligning each silicon wafer, preliminarily bonding the silicon wafers, and then applying thermal treatment at a high temperature of about 1000° C.

In silicon direct bonding technology, however, the preliminarily bonding process is performed using only intermolecular attraction, so even fine impurities on the surface of a wafer may lead to poor bonding quality. Accordingly, it is significantly difficult to bond several layers of silicon wafers through the use of a silicon direct bonding technology sensitive to external environmental conditions, and thus it is difficult to expect high yield in bonding.

### SUMMARY OF THE INVENTION

An aspect of the present invention provides an inkjet head and a manufacturing method thereof allowing for improved manufacturing yield due to the densification and facilitation of bonding between substrates by using anodic bonding between a silicon substrate and a ceramic substrate.

According to an aspect of the present invention, there is provided an inkjet head, the inkjet head including: an upper substrate formed of a silicon material and having an ink chamber storing ink provided therein; an intermediate substrate bonded to the upper substrate, formed of a low temperature co-fired ceramic material, and having a connection path and a restrictor provided therein while the connection path and the restrictor are connected to the ink chamber; and a lower substrate bonded to the intermediate substrate, formed of a silicon material, and having a nozzle connected to the connection path provided therein.

The intermediate substrate may have a difference in thermal expansion coefficient by 2 ppm/C or less in comparison with the upper or lower substrate.

The restrictor may have a diameter of 100 μm or less.

The restrictor may have a smaller diameter than the connection path.

The connection path may include a plurality of filter holes.

According to another aspect of the present invention, there is provided a method of manufacturing an inkjet head, the method including: providing an upper substrate formed of a silicon material and having an ink chamber formed therein; providing an intermediate substrate formed of a low temperature co-fired ceramic material and having a connection path and a restrictor formed therein while the connection path and the restrictor are connected to the ink chamber; providing a lower substrate formed of a silicon material and having a nozzle connected to the connection path formed therein; and bonding the intermediate substrate to the upper substrate, the lower substrate, or the upper and lower substrates.

The intermediate substrate may have a difference in thermal expansion coefficient by 2 ppm/C or less in comparison with the upper or lower substrate.

The restrictor may have a diameter of 100 μm or less.

The restrictor may have a smaller diameter than the connection path.

The connection path may include a plurality of filter holes.

The bonding of the intermediate substrate to each of the upper and lower substrate may include an anodic bonding.

The anodic bonding may be performed by applied voltage in a range of 800 V to 1000 V at a temperature of 400° C. to 650° C.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating an inkjet head according to an exemplary embodiment of the present invention; and

FIGS. 2A through 2C are schematic cross-sectional views illustrating a method of manufacturing an inkjet head according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

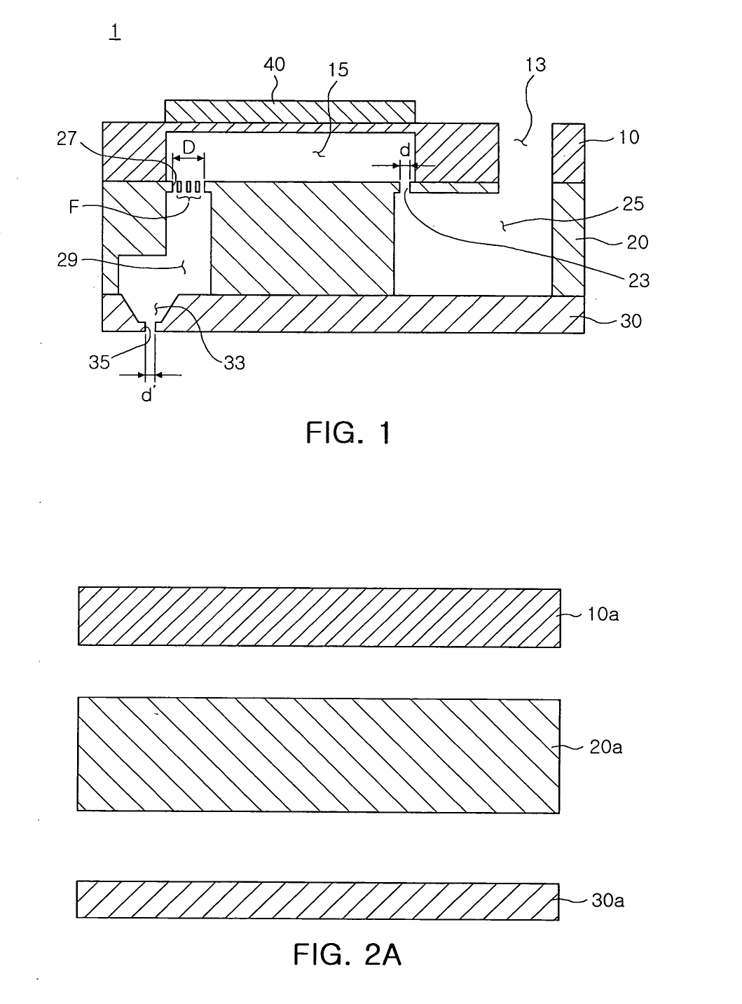

FIG. 1 is a schematic cross-sectional view illustrating an inkjet head according to an exemplary embodiment of the present invention.

Referring to FIG. 1, an inkjet head 1 includes an upper substrate 10 having an ink chamber 15 for storing ink formed therein; an intermediate substrate 20 bonded to the upper substrate 10, formed of a ceramic material, and having a connection path 27 and a restrictor 23 formed therein while the connection path 27 and the restrictor 23 are connected to the ink chamber 15; and a lower substrate 30 bonded to the intermediate substrate 20 and having a nozzle 35 connected to the connection path 27 formed therein.

Here, the upper and lower substrates 10 and 30 may be formed by processing a silicon substrate having good workability. In the upper substrate 10, the ink chamber 15 is formed to accommodate and pressurize ink. In the lower substrate 30, the nozzle 35 is formed to eject the ink in the form of droplets. Since the upper and lower substrates 10 and 30 have structures required to ensure a certain degree of precision among the structures of the inkjet head 1, in this embodiment they are manufactured by processing a silicon substrate having good workability.

In contrast to the upper and lower substrates 10 and 30 formed by processing the silicon substrate, the intermediate substrate 20 may be formed by processing a ceramic substrate, especially, a low temperature co-fired ceramic (LTCC) substrate. It is very important that the LTCC substrate has firing behaviors similar to those of the silicon substrates constituting the upper and lower substrates 10 and 30, and thus to maintain the precision of dimensions of the structures in the inkjet head 1 even after firing. Accordingly, in the present embodiment, the intermediate substrate 20 is formed by using an LTCC substrate having a difference in thermal expansion coefficient by 2 ppm/C or less, as compared to that of the upper or lower substrate 10 or 30. This is because using such an LTCC substrate for the intermediate substrate 20, in which the LTCC substrate has little difference in thermal expansion coefficient in comparison with the upper or lower substrate 10 or 30, may allow for stable bonding at a bonding interface between individual structures of the inkjet head without distortion or looseness even after firing.

The upper substrate 10 may further include an ink inlet 13. The intermediate substrate 20 may further include an ink path 29 connected to the connection path 27 and a reservoir 25 connected to the restrictor 23. The lower substrate 30 may further include a damper 33 formed between the ink path 29 and the nozzle 35. Also, the upper substrate 10 may further include a piezoelectric actuator 40 allowing ink to be moved by pressurizing the ink chamber 15. Here, the restrictor 23 may have a diameter d smaller than the diameter D of the connection path 27 to efficiently adjust the ink ejection amount. Also, the connection path 27 may further include a plurality of filter holes constituting an ink filter F.

In the case that a plurality of substrates are fabricated by processing silicon substrates and they are bonded together to thereby manufacture an inkjet head, bonding between the silicon substrates may not be facilitated. Also, in the case that a bond contains a defect, the defect may cause general bonding failure.

According to the present embodiment, the intermediate substrate 20, disposed between the upper and lower substrates 10 and 30 formed by processing the silicon substrates, is formed by processing the LTCC substrate having firing behaviors similar to those of the silicon substrates, thereby forming a structure having an essential function of the inkjet head 1 and improving bonding strength between each substrates 10, 20 and 30 of the inkjet head 1. That is, by taking advantage of the fact that bonding strength between a ceramic substrate and a silicon substrate is greater than bonding strength between silicon substrates, the upper and lower substrates 10 and 30 are manufactured by using the silicon substrates and the intermediate substrate 20 is manufactured by using the LTCC substrate. In this manner, a bonding structure of silicon substrate-LTCC substrate-silicon substrate is formed.

The LTCC substrate has good workability, and also it has superior hardness in comparison to the silicon substrate. Accordingly, the connection path 27 and the restrictor 23 requiring for precise processes are formed in the intermediate substrate 20 formed by processing the LTCC substrate.

Here, the restrictor 23 may commonly have a diameter d of 100 μm or less. Its diameter is designed to show an optimal ejection behavior in comparison with the diameter d′ of the nozzle 35.

The restrictor 23 is a path transferring ink from the reservoir 25 to the ink chamber 15. The ink introduced from the ink inlet 13 is stored in the reservoir 25 and the stored ink is transferred through the restrictor 23. The ink is transferred to the ink chamber 15 according to the driving force of the piezoelectric actuator 40 allowing the ink to be moved by pressurizing the ink chamber 15. Then, the ink is accommodated in the damper 33 through the connection path 27. After that, the ink is ejected to a printing medium in the form of droplets through the nozzle 35. Accordingly, the ink ejection amount may be adjusted according to the diameter d of the restrictor 23 formed at the boundary between the reservoir 25 and the ink chamber 15 and the diameter d′ of the nozzle 35.

The connection path 27 serves to adjust the amount of ink transferred from the ink chamber 15 to the nozzle 35, by being formed to be narrowed as compared to that of an existing inkjet head. The damper 33 allows the ink ejected by the piezoelectric actuator 40 from the ink chamber 15 to be transferred to the nozzle 35. Here, the damper may be variably formed by changing its shapes, thereby adjusting the amount of ink received from the ink chamber 15 and the amount of ink transferred to the nozzle 35. The damper 33 is optional, so the formation of the damper 33 may be omitted.

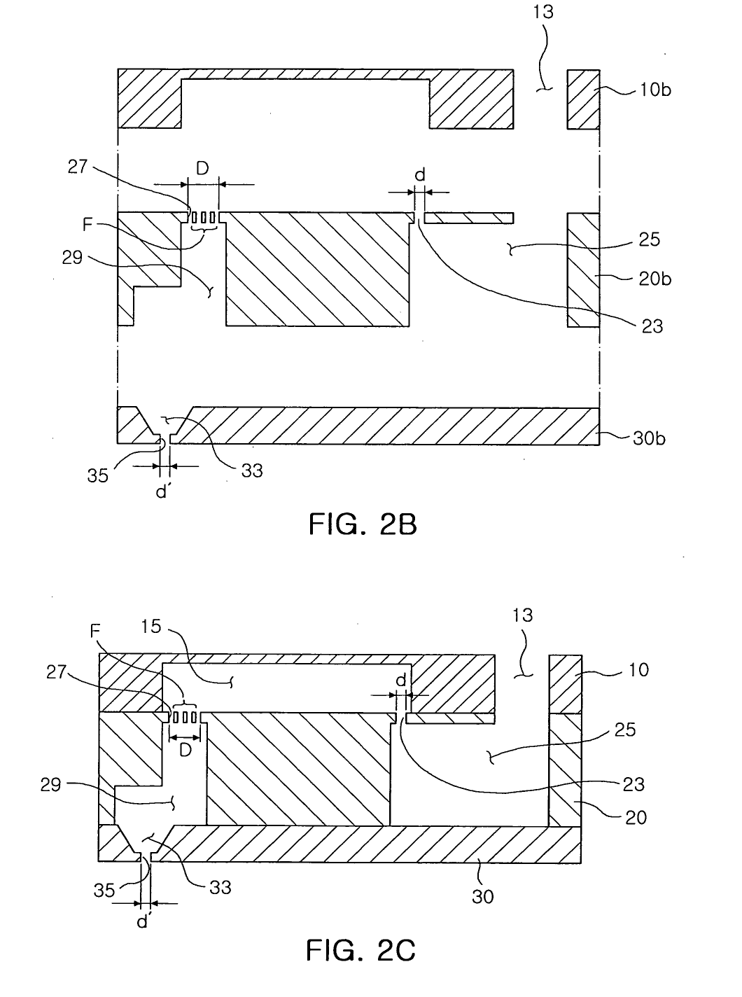

Hereinafter, a method of manufacturing an inkjet head according to an exemplary embodiment of the invention will be described with reference to FIGS. 2A through 2C.

FIGS. 2A through 2C are schematic cross-sectional views illustrating a method of manufacturing an inkjet head according to an exemplary embodiment of the present invention.

First of all, referring to FIGS. 2A through 2C, each of upper and lower substrates 10a and 30a formed of a silicon material is disposed to have an intermediate substrate 20a formed of an LTCC material interposed therebetween.

Next, the upper substrate 10a formed of the silicon material is processed to manufacture an upper substrate 10b including the ink chamber 15 and the ink inlet 13, and the lower substrate 30a formed of the silicon material is processed to manufacture a lower substrate 30b including the damper 33 and the nozzle 35. The intermediate substrate 20a formed of the LTCC material is processed to manufacture an intermediate substrate 20b including the connection path 27 connected to the ink chamber 15, the ink path 29, the restrictor 23, and the reservoir 25.

It is very important that the LTCC substrate has firing behaviors similar to those of the silicon substrates constituting the upper and lower substrates 10 and 30, and thus to maintain the precision of dimensions of the structures in the inkjet head 1 even after firing. Accordingly, in the present embodiment, the intermediate substrate 20 is formed by using an LTCC substrate having a difference in thermal expansion coefficient by 2 ppm/C or less, as compared to that of the upper or lower substrate 10 or 30. This is because using such an LTCC substrate for the intermediate substrate 20, in which the LTCC substrate has little difference in thermal expansion coefficient in comparison with the upper or lower substrate 10 or 30, may allow for stable bonding at a bonding interface between individual structures of the inkjet head without distortion or looseness even after firing.

Here, the restrictor 23 may commonly have a diameter d of 100 μm or less. Its diameter d is designed to show an optimal ejection behavior, as compared to the diameter d′ of the nozzle 35.

The restrictor 23 is a path which is designed to transfer ink from the reservoir 25 to the ink chamber 15. The ink introduced from the ink inlet 13 is stored in the reservoir 25 and the stored ink is transferred through the restrictor 23. The ink is transferred to the ink chamber 15 according to the driving force of the piezoelectric actuator 40 allowing the ink to be moved by pressurizing the ink chamber 15. Then, the ink is accommodated in the damper 33 through the connection path 27. After that, the ink is ejected to a printing medium in the form of droplets through the nozzle 35. Accordingly, the ink ejection amount may be adjusted according to the diameter d of the restrictor 23 formed at the boundary between the reservoir 25 and the ink chamber 15 and the diameter d′ of the nozzle 35.

Here, the connection path 27 is bonded after being formed to be narrowed as compared to that of an existing inkjet head, thereby adjusting the amount of ink transferred from the ink chamber 15 to the nozzle 35. The connection path 27 may further include a plurality of filter holes constituting an ink filter F.

Here, the damper 33 allows the ink ejected by the piezoelectric actuator 40 from the ink chamber 15 to be transferred to the nozzle 35. The damper may be variably formed by changing its shapes, thereby adjusting the amount of ink received from the ink chamber 15 and the amount of ink transferred to the nozzle 35. The damper 33 is optional, so the formation of the damper 33 may be omitted.

Then, the process-finished upper and intermediate substrates 10b and 20b are bonded together and the process-finished intermediate and lower substrates 20b and 30b are bonded together, thereby forming the bonded upper, intermediate and lower substrates 10, 20 and 30.

Here, the upper substrate 10b formed by processing the silicon substrate and the intermediate substrate 20b formed by processing the LTCC substrate are bonded by anodic bonding. Also, the intermediate substrate 20b formed by processing the LTCC substrate and the lower substrate 30b formed by processing the silicon substrate are bonded by anodic bonding.

Anodic bonding leads to ionic bonding between materials to thereby prevent ink leakage at a bonding interface and allow for physically and chemically stable bonding. The LTCC substrate and the silicon substrate are allowed to be bonded together due to the ion bonding therebetween without a separate adhesive layer, thereby preventing physical and chemical reactions of ink at the bonding interface and forming a strong head structure. By the use of the anodic bonding performed by applied voltage in the range of approximately 800 V to 1000 V at a temperature of approximately 400° C. to 650° C., the LTCC substrate and the silicon substrate may be bonded together after melting the interface therebetween.

This basic structure of the inkjet head fabricated in the above manner is combined with the piezoelectric actuator 40, thereby completing the manufacturing of the inkjet head 1 as shown in FIG. 1.

The inkjet head and the manufacturing method thereof according to exemplary embodiments of the invention are allowed to secure precision and maintain hardness by bonding the silicon substrate and the ceramic substrate.

Also, the silicon substrate and the ceramic substrate are bonded by the anodic bonding, whereby the densification and facilitation of bonding between the substrates are achieved and the manufacturing yield of the inkjet head is enhanced.

As set forth above, according to exemplary embodiments of the invention, there is provided an inkjet head and a manufacturing method thereof capable of securing precision and maintaining hardness by bonding a silicon substrate and a ceramic substrate.

Also, according to exemplary embodiments of the invention, there is also provided an inkjet head and a manufacturing method thereof allowing for improved manufacturing yield due to the densification and facilitation of bonding between substrates by using anodic bonding between a silicon substrate and a ceramic substrate.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
an upper substrate formed of a silicon material and having an ink chamber storing ink provided therein;
an intermediate substrate bonded to the upper substrate, formed of a low temperature co-fired ceramic material, and having a connection path and a restrictor provided therein, the connection path and the restrictor connected to the ink chamber; and
a lower substrate bonded to the intermediate substrate, formed of a silicon material, and having a nozzle connected to the connection path provided therein.

2. The inkjet head of claim 1, wherein the intermediate substrate has a difference in thermal expansion coefficient by 2 ppm/C or less in comparison with the upper or lower substrate.

3. The inkjet head of claim 1, wherein the restrictor has a diameter of 100 μm or less.

4. The inkjet head of claim 1, wherein the restrictor has a smaller diameter than the connection path.

5. The inkjet head of claim 1, wherein the connection path includes a plurality of filter holes.

6. A method of manufacturing an inkjet head, the method comprising:
providing an upper substrate formed of a silicon material and having an ink chamber formed therein;
providing an intermediate substrate formed of a low temperature co-fired ceramic material and having a connection path and a restrictor formed therein while the connection path and the restrictor are connected to the ink chamber;
providing a lower substrate formed of a silicon material and having a nozzle connected to the connection path formed therein; and
bonding the intermediate substrate to the upper substrate, the lower substrate, or the upper and lower substrates.

7. The method of claim 6, wherein the intermediate substrate has a difference in thermal expansion coefficient by 2 ppm/C or less in comparison with the upper or lower substrate.

8. The method of claim 6, wherein the restrictor has a diameter of 100 μm or less.

9. The method of claim 6, wherein the restrictor has a smaller diameter than the connection path.

10. The method of claim 6, wherein the connection path includes a plurality of filter holes.

11. The method of claim 6, wherein the bonding of the intermediate substrate to each of the upper and lower substrate comprises an anodic bonding.

12. The method of claim 11, wherein the anodic bonding is performed at a temperature of 400° C. to 650° C.

13. The method of claim 11, wherein the anodic bonding is performed by applied voltage in a range of 800 V to 1000 V.
